(19) United States
(12) Patent Application Publication
(10) Pub. No.: US 2007/0134470 A1
(43) Pub. Date: Jun. 14, 2007

(54) Multilayer, white, biaxially oriented polyester film

(76) Inventors: Martin Jesberger, Mainz (DE); Herbert Peiffer, Mainz (DE); Gottfried Hilkert, Saulheim (DE); Franz Hora, Kriftel (DE)

Correspondence Address: PROPAT, L.L.C., 425-C SOUTH SHARON AMITY ROAD, CHARLOTTE, NC, 28211-2841, US

(21) Appl. No.: 11/606,744

(22) Filed: Nov. 30, 2006

(30) Foreign Application Priority Data
Dec. 9, 2005 (DE) 10 2005 058 917.0
Dec. 9, 2005 (DE) 10 2005 058 915.4

(51) Int. Cl. G11B 5/64; B32B 27/36; B32B 27/30; B32B 27/20; B32B 5/16

(52) U.S. Cl. 428/141; 428/323; 428/480; 428/910; 428/331; 428/483; 264/210.7; 264/290.2

(57) ABSTRACT

This invention relates to a white, biaxially oriented polyester film, preferably formed of PET, with a base layer and with at least one outer layer. The base layer includes a concentration of from 3 to 15% by weight of a whitening pigment, and the outer layer includes a concentration of from 2 to 15% by weight of a whitening pigment and from 0.01 to 2% by weight of an antiblocking agent. The antiblocking agent has a median particle diameter of from 2 to 8 μm. Optionally, at least one surface of the film has a functional coating. The film is particularly suitable as lid film for food-or-drink containers.

### CROSS-REFERENCE TO RELATED APPLICATIONS

This application claims priority to its parent applications, German Patent Application 10 2005 058 917.0, filed Dec. 9, 2005 and German Patent Application 10 2005 058 915.4 filed Dec. 9, 2005, which are hereby incorporated by reference herein, in their entirety.

### FIELD OF THE INVENTION

This invention relates to a multilayer, white, biaxially oriented polyester film comprising a base layer (B), which comprises a thermoplastic polyester and a white pigment, and also at least one outer layer (A). The outer layer (A) also comprises an antiblocking agent, alongside a white pigment (whitening pigment). If appropriate, the inventive film has at least one functionalized surface which, for example, has good adhesion to other polymer layers or to other metal layers or to printing inks. To this end, this surface is in-line-coated with an adhesion-promoting layer. The invention further relates to a process for production of the film and to the use of the film.

### BACKGROUND OF THE INVENTION

White, biaxially oriented polyester films, in particular for the lid application in yoghurt pots, are known in the prior art.

EP-B-0 605 130 describes a multilayer, coextruded composite film whose thickness is in the range from 30 to 400 μm. The film comprises an opaque crystalline first polyester layer which is substantially impermeable to visible light, its density being more than 1.30 g/m³, its thickness being greater than or equal to 25 μm and its deformation index being greater than or equal to 2.5%. The deformation index is measured at a temperature of 200° C. and under a pressure of 2 MPa. Alongside this, the film comprises a transparent crystalline second polyester layer which is “substantially permeable to visible light”, its TOD (transmission optical density) being from 0.005 to 0.2. For the purposes of the invention, this layer retains transparency if it comprises less than 2% of particles, their particle size being from 0.1 to 10 μm. The film features good opacity but has shortcomings in its production (non-ideal roll formation), in its processing to give lids, and in particular in optical properties.

EP-A-1 176 004 describes a white, biaxially oriented, generally single-layer polyester film with a base layer (B) which, because of its specific mechanical properties, has very good suitability as lid film, in particular as lid film for yoghurt pots. The film is characterized in that the R value is not more than 45 daN/mm² and the eₘₐₓ ratio is not more than 2.5. Compliance with these values makes the film less likely to delaminate and gives it good performance in peeling from the pot. Another feature of the film is good opacity, but it still has shortcomings in its production (non-ideal roll formation) and in optical properties.

### SUMMARY OF ADVANTAGEOUS EMBODIMENTS OF THE INVENTION

It was therefore an object of the present invention to provide a white, biaxially oriented polyester film, in particular for the yoghurt lid application, which when compared with the polyester films known in the prior art features improved properties, in particular improved ease of production (in particular via improved winding), improved processing performance and improved optical properties (gloss, appearance). It will also be advantageous for the film to feature good adhesion to inks, adhesives, primers, and good metallic and ceramic layers.

### BRIEF DESCRIPTION OF THE DRAWINGS

FIG. 1 is a graphical illustration of an exemplary relative cumulative particle size distribution curve.

### DETAILED DESCRIPTION OF ADVANTAGEOUS EMBODIMENTS OF THE INVENTION

According to the invention, the object is achieved via provision of a white, coextruded, biaxially oriented polyester film which has a base layer (B) and at least one outer layer (A), where
a) the base layer (B) comprises a concentration of from 3 to 15% by weight of a whitening pigment (based on the weight of the base layer (B)) and
b) the outer layer (A) comprises a concentration of from 2 to 15% by weight of a whitening pigment and also from 0.01 to 2% by weight of an antiblocking agent whose median particle diameter (d₅₀) is in the range from 2 to 8 μm (% by weight data based on the weight of the outer layer (A)).

In order to achieve the desired adhesion properties, it is advantageous that moreover
c) at least one of the two surfaces of the film bears a functional layer or has been functionalized.

This layer is preferably applied in the form of an aqueous dispersion to the film.

The term whitening pigment also includes mixtures of various whitening pigments or mixtures of whitening pigments of identical constitution but different particle size.

The white, biaxially oriented film according to the present invention preferably has a structure of at least two layers. It is then comprised of the base layer (B) and of the outer layer (A) applied thereto via coextrusion, both layers comprising at least one white pigment and the outer layer (A) comprising an additional antiblocking agent favorable to the production of the film (winding). The inventive film can moreover have, on at least one surface of the film, a preferably adhesion-promoting layer which is preferably applied in the form of an aqueous dispersion to the film.

In the preferred embodiment, the film has a structure of three, or more than three, layers, for example four or five layers.

In the preferred three-layer embodiment, the film is comprised of the base layer (B), of the outer layer (A), and of an outer layer (C) opposite to the outer layer (A)—layer structure ABC. Particular preference is given here to the symmetrical three-layer structure (ABA), in which the layers (A) and (C) can be regarded as identical within the bounds of variations caused by production. This film structure gives the best conditions for satisfactory processing of the film. By way of example, asymmetrical film structures such as (ABC) or in particular the abovementioned (AB) structure (cf. in this connection EP-B 0 605 130) have a certain tendency toward curling, which is undesirable. The tendency toward curling is mostly visible only when lids are stamped out from the film web. In this instance, the lid fails to lay flat on a level substrate but becomes curved either with a concave or convex shape. In this instance, it can by way of example become lodged during onward transport or during introduction into the sealing equipment, the result being an increase in rejection rate.

It has been found that when, as is preferred, the colorant pigment (white pigment) used comprises substantially TiO₂, the film becomes less susceptible to tearing and delamination. When TiO₂ is added, preferably by way of masterbatch technology, an advantage is that color differences, e.g. due to inconsistent properties of recycled material, can easily be corrected. When TiO₂ is used as sole pigment, the film becomes extremely smooth and therefore more glossy, but has a tendency toward blocking.

Preferred polymers for the base layer (B) and for the outer layers:

Base Layer (B)

The base layer (B) of the film is preferably comprised of at least 80% by weight, in particular at least 85% by weight and particularly preferably at least 90% by weight, of a thermoplastic polyester. Examples of polyesters suitable for this purpose are those comprised of ethylene glycol and terephthalic acid (=polyethylene terephthalate, PET), from ethylene glycol and naphthalene-2,6-dicarboxylic acid (=polyethylene 2,6-naphthalate PEN), from 1,4-bishydroxymethylcyclohexane and terephthalic acid (=poly-1,4-cyclohexanedimethylene terephthalate, PCDT), and also from ethylene glycol, naphthalene-2,6-dicarboxylic acid and biphenyl-4,4′-dicarboxylic acid (=polyethylene 2,6-naphthalate bibenzoate, PENBB). Particular preference is given to polyesters comprised of at least 90 mol %, preferably at least 95 mol %, of ethylene glycol units and terephthalic acid units or of ethylene glycol units and naphthalene-2,6-dicarboxylic acid units. The remaining monomer units are derived from other aliphatic, cycloaliphatic, or aromatic diols and/or other dicarboxylic acids. The base layer is preferably comprised of PET. Examples of other suitable aliphatic diols are diethylene glycol, triethylene glycol, aliphatic glycols of the formula HO—(CH₂)ₙ—OH, where n is an integer from 3 to 6 (in particular propane-1,3-diol, butane-1,4-diol, pentane-1,5-diol, and hexane-1,6-diol), or branched aliphatic glycols having up to 6 carbon atoms. Among the cycloaliphatic diols, mention should be made of cyclohexanediols (in particular cyclohexane-1,4-diol). Examples of other suitable aromatic diols are those of the formula HO—C₆H₄—X—C₆H₄—OH where X is —CH₂—, —C(CH₃)₂—, —C(CF₃)₂—, —O—, —S— or —SO₂—. Other suitable bisphenols are those of the formula HO—C₆H₄—C₆H₄—OH.

Preferred other aromatic dicarboxylic acids are benzenedicarboxylic acids, naphthalenedicarboxylic acids (such as naphthalene-1,4- or -1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid), or stilbene-x,x′-dicarboxylic acids. Among the cycloaliphatic dicarboxylic acids, mention may be made of cyclohexanedicarboxylic acids (in particular cyclohexane-1,4-dicarboxylic acid). Among the aliphatic dicarboxylic acids, particularly suitable compounds are the (C₃-C₁₉)alkanediacids, where the alkane moiety may be straight-chain or branched.

By way of example, the polyesters may be prepared by the known transesterification process. The starting materials for this are dicarboxylic esters and diols, which are reacted using the customary transesterification catalysts, such as the salts of zinc, of calcium, of lithium, of magnesium, and of manganese. The intermediates are then polycondensed in the presence of widely used polycondensation catalysts, such as antimony trioxide or titanium salts. The preparation may be carried out just as successfully by the direct esterification process in the presence of polycondensation catalysts. This process starts directly from the dicarboxylic acids and the diols.

Outer Layer (A)

The polymers used for the outer layer (A), for any other outer layer (C) present and for any other intermediate layers (D) and (E) present are preferably the same as those used stated above for the base layer (B). In particular, the base layer and the other layers comprise identical polymers (polyesters).

White Pigment

In order to achieve the abovementioned properties, in particular the desired whiteness of the film, the necessary white pigments are incorporated into the base layer (B) and at least into one outer layer (A), but possibly also into other layers present. Titanium dioxide, barium sulfate, zinc sulfide or zinc oxide can be used. It is preferable that TiO₂ is used as sole colorant pigment. In the preferred embodiment, it is added in the form of an extrusion masterbatch to the virgin polymer. Typical ranges for the TiO₂ concentration in the extrusion masterbatch are from 20 to 70% by weight. The titanium dioxide can be either of rutile type or of anatase type or can be a mixture comprised of rutile type and anatase type. In the base layer it is preferable to use titanium dioxide of anatase type and in the outer layer it is preferable to use titanium dioxide of rutile type. The grain size of the titanium dioxide is generally from 0.05 to 0.5 μm, preferably from 0.1 to 0.3 μm. The pigments incorporated in the intended concentrations give the film a brilliant white appearance.

In order to obtain the desired whiteness (preferably >60) and the desired low transparency (preferably <60%) of the film, the base layer (B) should have a high filler level. The concentration of the white pigments for achieving the desired low transparency, based on the total weight of the layer in which they are present, is from 3 to 15% by weight, preferably from 3.5 to 14% by weight and particularly preferably from 4.0 to 13% by weight.

In one particular embodiment, in order to provide a further rise in whiteness, optical brighteners can be added to the base layer and/or to the other layers. Examples of suitable optical brighteners are HOSTALUX® KS from Clariant or EASTOBRITE® OB-1 from Eastman.

According to the invention, the outer layer (A), and if appropriate also the other outer layer (C) and if appropriate other intermediate layers (D) and (E), comprise(s) a concentration of from 2 to 15% by weight of at least one whitening pigment. The concentration here is preferably selected in such a way that the (Berger) whiteness of the film is greater than 60. Otherwise, the optical properties of the film are less suitable for the preferred application (e.g. sealed lid film on yoghurt pots), because the translucency of the film can be excessive.

If the outer layer (A) comprises a whitening pigment system whose concentration of the whitening pigment is less than or equal to 2%, the brilliant white character of the film is lost and the print subsequently applied to this side appears to the viewer to be defective. In contrast, if the outer layer (A) comprises a whitening pigment system whose concentration of the whitening pigment is greater than 15% by weight, there is a major risk of chalking of the white pigment.

It has been found that the windability of the film and the roll formation can be markedly improved if the outer layer (A) and if appropriate also the other outer layer (C) comprise(s) an antiblocking agent. It has been found here that in particular the median particle diameter d₅₀ and the concentration of the antiblocking agent additionally used in the outer layer (A) are important for good windability and for good processability of the film.

In order to improve the winding and processability of the film, at least the outer layer (A) comprises an antiblocking agent whose median diameter (d₅₀) is in a range which is preferably from 2 to 8 μm.

In the preferred embodiment, the outer layer (A) comprises an antiblocking agent whose median diameter is in the range from 2.1 to 7 μm, and in the particularly preferred embodiment the outer layer (A) comprises an antiblocking agent whose median diameter is in the range from 2.2 to 6 μm.

If, in contrast, the outer layer (A) comprises an antiblocking agent whose median diameter is outside the preferred range, the effect of this on winding, on processability and on the optical properties of the film is adverse.

If the outer layer (A) comprises an antiblocking agent whose median diameter is greater than 8 μm, the optical properties of the film and its winding become poorer. In contrast, if the outer layer (A) of the film comprises an antiblocking agent whose median diameter is smaller than 2 μm, the winding of the film becomes poorer, as also therefore does roll formation.

The outer layer (A) and if appropriate also the other outer layer (C) are provided with the antiblocking agent in order to improve winding performance and processability. The concentration of the antiblocking agents in the outer layer (A) and if appropriate also in the other outer layer (C) is from 0.05 to 1.8% by weight in the preferred embodiment and is from 0.1 to 1.6% by weight in the particularly preferred embodiment, and substantially depends on the optical properties to be achieved and on the windability to be achieved in the film.

Typical antiblocking agents are inorganic and/or organic particles, such as calcium carbonate, amorphous silica, talc, magnesium carbonate, barium carbonate, calcium sulfate, lithium phosphate, calcium phosphate, magnesium phosphate, aluminum oxide, LiF, the calcium, barium, zinc or manganese salts of the dicarboxylic acids used, kaolin or crosslinked organic particles, such as polystyrene particles or acrylate particles.

It is also possible to use mixtures of two or more different antiblocking agents or mixtures of antiblocking agents of the same composition but different particle size, provided the mixtures satisfy the above-mentioned conditions with regard to total amount and median particle diameter. Antiblocking agents may be added to the polyester of the outer layer in the respectively advantageous concentrations, for example as a glycolic dispersion during the polycondensation or via masterbatches during extrusion.

Addition of the inventive concentration of antiblocking agent to the outer layer (A) also has the desired favorable effect on the roughness and the coefficient of friction of the outer layer (A). In order to achieve a further improvement in the processing performance of the film, the concentration of the antiblocking agent should in an advantageous case be selected in such a way as to achieve the following values for roughness and for the coefficient of friction.

The coefficient of friction (COF) of side (A) with respect to itself should preferably be less than or equal to 0.4. Otherwise, the winding performance of the film and its further processing are unsatisfactory.

The roughness of the outer layer (A), expressed as its Rₐ value, should preferably be greater than or equal to 40 nm and less than or equal to 150 nm. Rₐ values smaller than 40 nm have adverse effects on the winding performance and processing performance of the film, and Rₐ values greater than 150 nm impair the optical properties (gloss) of the film. The statements relating to coefficient of friction and roughness of the outer layer (A) are based on the untreated/uncoated outer layer (A).

The base layer and the outer layers (A) and (C) particularly preferably in each case comprise a whitening pigment, in particular titanium dioxide, which is identical in all of the layers. Likewise, it is preferable that in each case an identical pigment, in particular silicon dioxide, is used as antiblocking agent in the outer layers.

The thickness of the outer layer (A) and/or (C) of the film is generally in the range from 0.4 μm to 6 μm, preferably in the range from 0.5 to 5 μm and particularly preferably in the range from 0.6 to 4 μm.

The base layer (B), and also the other layers, e.g. (A) and (C), can also comprise conventional additives, e.g. stabilizers. They are usually added to the polymer or to the polymer mixture prior to melting. Examples of stabilizers used are phosphorus compounds, such as phosphoric acid or phosphoric esters.

The thickness of the polyester film according to the present invention can vary within wide limits. It is preferably from 5 to 500 μm, in particular from 8 to 400 μm and particularly preferably from 10 to 300 μm, the proportion of the base layer preferably being from 50 to 95% of the total thickness.

At least one film surface of the inventive film can have a functional coating and/or treatment. The contact angle of this surface with water is ≦64°, preferably ≦62° and particularly preferably ≦60°. This surface in particular has increased adhesion to other materials.

This is achieved via corona treatment and, respectively, flame treatment, which usually follows the heat-setting of the film. The treatment can also take place at other points in the film production process, for example after longitudinal stretching. As an alternative or in addition to the surface treatment described above, the film can also be coated with a functional coating on one (or both) surface(s) in such a way that the thickness of the coating on the finished film is preferably from 5 to 2000 nm, in particular from 20 to 500 nm and particularly preferably from 30 to 200 nm. The coating is preferably applied in-line, i.e. during the film production process, advantageously prior to transverse stretching. Particular preference is given to application by means of the reverse gravure roll coating process, which can apply the coating extremely homogeneously in layer thicknesses extending to 200 nm. Preference is likewise given to application via the Meyer rod process, which can achieve relatively great coating thicknesses. The form in which the coatings are applied is preferably that of solutions, suspensions or dispersions, particularly preferably that of an aqueous solution, suspension or dispersion. The coatings mentioned give the surface of the film an additional function; by way of example, making the film sealable, printable, metallizable, sterilizable, or antistatic, or improving, for example, the odor barrier or permitting adhesion to materials which would not otherwise adhere to the surface of the film. Examples of substances/compositions which give additional functionality are: acrylates, as described by way of example in WO 94/13476, ethyl-vinyl alcohols, PVDC, water glass (Na₂SiO₄), hydrophilic polyesters (PET/IPA polyesters containing sodium salt of 5-sulfoisophthalic acid and described by way of example in EP-A-0 144 878, U.S. Pat. No. 4,252,885 or EP-A-0 296 620), polyvinyl acetates as described by way of example in WO 94/13481, polyurethanes, the alkali metal or alkaline earth metal salts of C₁₀-C₁₈ fatty acids, butadiene copolymers with acrylonitrile or methyl methacrylate, or methacrylic acid or esters thereof.

The form in which the substances/compositions mentioned are applied to one or both surfaces of the film is that of dilute solution, emulsion or dispersion, preferably that of aqueous solution, emulsion or dispersion, and the solvent is then evaporated. If the coatings are applied in-line prior to transverse stretching, the heat-treatment during transverse stretching and subsequent heat-setting is usually sufficient to evaporate the solvent and to dry the coating.

In one preferred embodiment of the invention, a copolyester coating is used to achieve the improved adhesion. The preferred coating copolyesters are prepared via polycondensation of (α) isophthalic acid, (β) an aliphatic dicarboxylic acid having the formula
HOOC(CH₂)ₙCOOH,
where n is in the range from 1 to 11, (γ) a sulfo monomer containing an alkali metal sulfonate group on the aromatic moiety of an aromatic dicarboxylic acid, and (δ) at least one aliphatic or cycloaliphatic alkylene glycol having about 2-11, preferably 2-8, particularly preferably 2-6, carbon atoms. The total number of acid equivalents present are to be in essence the same in molar terms as the total number of glycol equivalents present.

It has been found that the relative proportions of components (α), (β), (γ) and (δ) used to prepare the preferred copolyester coatings are important for the achievement of a coated film with satisfactory adhesion. By way of example, at least about 65 mol % of isophthalic acid (component α) should preferably be present as acid component. Component (α) is preferably pure isophthalic acid, its amount present being about 70-95 mol %. The rule for component (β) is that satisfactory results are obtained with any acid of the formula mentioned, but preference is given to adipic acid, azelaic acid, sebacic acid, malonic acid, succinic acid, glutaric acid, or a mixture of these acids. The desirable amount within the range stated is preferably from 1 to 20 mol %, based on the acid components of the copolyester, if component (β) is present in the composition. The amount present in this system of the monomers forming component (γ) of the preferred copolyester coating should preferably be at least 5 mol %, so that the primer coating becomes water-dispersible. The amount of monomer of component (γ) is particularly preferably about 6.5-12 mol %. The amount present of the glycol component (δ) is approximately stoichiometric.

In another preferred embodiment of the invention, an acrylate coating is used to achieve the improved adhesion. The acrylic copolymers preferably used are comprised in essence of at least 50% by weight of one or more polymerized acrylic and/or methacrylic monomers and 1-15% by weight of a copolymerizable comonomer which in the copolymerized state is capable of intermolecular crosslinking on exposure to an elevated temperature, if appropriate without addition of any separate resin-like crosslinking agent.

The amount present of the acrylic component of the adhesion-promoter copolymers is preferably from 50 to 99% by weight, and this component is preferably comprised of an ester of methacrylic acid, in particular of an alkyl ester whose alkyl group contains up to ten carbon atoms, examples being the methyl, ethyl, n-propyl, isopropyl, n-butyl, isobutyl, tert-butyl, hexyl, 2-ethylhexyl, heptyl, and n-octyl group. Acrylic copolymers which derive from a lower alkyl acrylate (C1-C4), in particular ethyl acrylate, give particularly good adhesion between the polyester roll and reprographic coatings and matt coatings applied thereto if they are used together with a lower alkyl methacrylate. It is very particularly preferable to use adhesion-promoter copolymers comprised of an alkyl acrylate, e.g. ethyl acrylate or butyl acrylate, together with an alkyl methacrylate, e.g. methyl methacrylate, in particular in identical molar proportions, their total amount preferably being from 70 to 95% by weight. In the acrylic/methacrylic combinations here, the proportion of the acrylate comonomer present is preferably from 15 to 65 mol %, and the proportion of the methacrylate comonomer present is preferably greater than that of the acrylate comonomer, generally by from 5 to 20 mol %. The proportion of the methacrylate present in the combination is preferably from 35 to 85 mol %.

In order to increase solvent resistance, suitable comonomers may be used for crosslinking, e.g. N-methylolacrylamide, N-methylolmethacrylamide, and the corresponding ethers; epoxy materials, e.g. glycidyl acrylate, glycidyl methacrylate, and allyl glycidyl ether; monomers containing carboxy groups, e.g. crotonic acid, itaconic acid, or acrylic acid; anhydrides, e.g. maleic anhydride or itaconic anhydride; monomers containing hydroxy groups, e.g. allyl alcohol and hydroxyethyl or hydroxypropyl acrylate or the corresponding methacrylates; amides, such as acrylamide, methacrylamide, or maleimide, and isocyanates, e.g. vinyl isocyanate or allyl isocyanate. Among the abovementioned crosslinking comonomers, preference is given to N-methylolacrylamide and N-methylolmethacrylamide, and specifically and primarily because copolymer chains in which one of these monomers is present are capable of condensing with one another on exposure to elevated temperatures and thus giving the desired intermolecular crosslinking. However, the solvent resistance which may, if appropriate, be desired in the preferred acrylate coating can also be achieved via the presence of a foreign crosslinking agent, e.g. a melamine- or urea-formaldehyde condensate. If no solvent resistance is needed, crosslinking agents can be omitted.

The preferred acrylate coating can be applied to one or both sides of the film. However, it is also possible to provide only one side of the film with the inventive coating and to apply another coating to the opposite side. The coating formulation can comprise known additives, e.g. antistatic agents, wetting agents, surfactants, pH regulators, antioxidants, dyes, pigments, antiblocking agents, e.g. colloidal SiO₂, etc. It is normally advisable to incorporate a surfactant in order to increase the ability of the aqueous coating to wet the backing film comprised of polyester.

In another preferred embodiment of the invention, a water-soluble or hydrophilic coating is used to achieve improved adhesion to hydrophilic layers or printing inks. In particular, the preferred hydrophilic coating can be achieved in three ways; via:
1. a mixture comprised of an aromatic copolyester (I-1) having a water-dispersible functional group and a polyvinyl alcohol (II-1);
2. a mixture comprised of an aromatic copolyester (I-2) having a water-dispersible functional group and a polyglycerol polyglycidyl ether (II-2); or
3. a mixture comprised of an aqueous polyurethane (I-3) and a polyvinyl alcohol (II-3).

The aromatic copolyesters (I-1 and I-2) are prepared from aromatic dicarboxylic acids, e.g. terephthalic acid, 2,6-naphthalenedicarboxylic acid or isophthalic acid, and from aliphatic diols which may, if appropriate, be branched diols or condensed diols, e.g. ethylene glycol, diethylene glycol, 2-methylpropanol, or 2,2-dimethylpropanol, and also from an ester-forming compound which bears a water-dispersible functional group. Examples of the functional groups are: hydroxy, carboxy, sulfonic acid groups, or phosphoric acid groups, or their salts. Preference is given to the salts of sulfonic acids and of carboxylic acids. The polyvinyl alcohol component (II-1 and II-3) used may comprise any polyvinyl alcohol which is water-soluble and can be prepared by normal polymerization methods. These polyvinyl alcohols are generally prepared via hydrolysis of polyvinyl acetates. The degree of hydrolysis should preferably be at least 70%, but more preferably from 80 to 99.9%. The polyglycerol polyglycidyl ethers (II-2) used preferably comprise reaction products of glycerol and epichlorohydrin having molecular weights of about 250-1200 g/mol. The aqueous polyurethane (I-3) is prepared from a polyol, e.g. a polyester with glycol end groups, polyoxyethylene glycol, polyoxypropylene glycol, polyoxytetramethylene glycol, or acrylic polyols, and from a diisocyanate, e.g. xylene diisocyanate, hexamethylene diisocyanate, dicyclohexylmethane 4,4′-diisocyanate, toluidine diisocyanate, phenylene diisocyanate, diphenylmethane 4,4′-diisocyanate, or naphthalene 1,5-diisocyanate.

In another preferred embodiment of the invention, the adhesion-promoting layer is comprised of an amino-functional silane, which also makes the film resistant to steam sterilization (no delamination of a laminate comprised by way of example of film, coating, adhesive or applied metallic and ceramic layers) and moreover makes it receptive to direct extrusion-coating with polymers.

The amino-functional silane is generally hydrolyzed in water and applied to one or more surfaces of the oriented polyester by conventional methods such as spray coating or roller coating. Once the silane coating has been dried, the polyester thus primed is steam-sterilizable and receptive to direct extrusion with other polymers. The extrusion-coating can be conducted by a conventional process.

In the widest sense, this aspect of the present invention is directed toward an oriented polyester film which has an adhesion-promoting layer which can make the film steam-sterilizable and receptive to direct extrusion-coating. The unhydrolyzed state of the adhesion-promoting layer is described via the following general formula:
(R¹)ₐSi (R²)_{b}(R³)_{c}.

The invention also comprises a steam-sterilizable laminate comprised of an oriented polyester film, of an adhesion-promoting layer and of a polymer directly extruded thereon.

After hydrolysis, silanes are water-soluble or water-dispersible, amino-functional silanes having particularly good water-solubility. It has been found that, even after steam sterilization, aminosilanes have good adhesion to inks, adhesives, primers, and metallic and ceramic layers, and likewise bring about good adhesion of extrusion-coated polymers to polyester films without any additional adhesion-promoting layer or corona treatment. The cut polyester film with aminosilane coating can be recycled.

Amino-functional silanes used for the purpose of this invention have the following formula in the unhydrolyzed state:
(R¹)ₐSi(R²)_{b}(R³)_{c},
in which R¹ contains at least one amino group; R² is a hydrolyzable group, e.g. a short-chain alkoxy group having from 1-8 carbon atoms, an acetoxy group, or a halide; and R³ is an unreactive, non-hydrolyzable group, either a short-chain alkyl group having from 1-8 carbon atoms or a phenyl group; in the formula, (a) is greater than or equal to 1; (b) is greater than or equal to 1; (c) is greater than or equal to 0; where a+b+c=4.

Examples of aminosilanes in accordance with this formula are N-2-(aminoethyl)-3-aminopropyltrimethoxysilane, 3-aminopropyltrimethoxysilane, 4-aminobutyltriethoxysilane, 4-aminobutyldimethylmethoxysilane, and p-aminophenyltrimethoxysilane. Preference is given to N-2-(aminoethyl)-3-aminopropyltrimethoxysilane having the following formula:
H₂N(CH₂)₂NH(CH₂)₃Si(OCH₃)₃.

In principle, the hydrolyzed aminosilane may be applied at any possible juncture during the production of the film, i.e. prior to or during the stretching process, and can also be applied to the finished film (for example) prior to wind-up.

The adhesion-promoting layer is prepared via mixing of aminosilane with water preferably in a range from 0.2 to 6% by weight. A weak acid, e.g. acetic acid, can optionally be added in order to promote the hydrolysis. At least one of the hydrolyzable groups of the silane is hydrolyzed to give a silanol group (SiOH). It is assumed that the hydrolysis product of the aminosilane has a partially hydrolyzed cyclic structure, the amino group probably forming ionic bonds to the silicon moiety of the molecule. The term “hydrolyzed” used here therefore also refers to these partially hydrolyzed structures.

EP-B-0 039 017 (pages 3-5) describes in detail the inventive coating described above, and is expressly incorporated herein at this point by way of reference. That specification also gives information about other specific combinations of these hydrolyzable aminosilanes.

The preferred copolyester coatings, acrylate coatings, silane coatings and hydrophilic coatings can moreover comprise other known additives, e.g. antistatic agents, wetting agents, surfactants, pH regulators, antioxidants, dyes, pigments, antiblocking agents, e.g. colloidal SiO₂, etc.

Production Process

The present invention also provides a process for production of the inventive films. It comprises the production of a multilayer film comprised of a base layer (B) and outer layer(s) and (A) (and C) via coextrusion and shaping of the melts to give a flat melt film and biaxial stretching of the film and heat-setting of the stretched film. If appropriate, the film is functionally coated during the production process.

First, the polymer or the polymer mixture for the individual layers is in each case compressed and plasticized in an extruder. The melts are simultaneously mutually superposed by extrusion through a flat-film die, and the extruded multilayer film is drawn off on one or more take-off rolls, whereupon it cools and solidifies.

The biaxial orientation is generally carried out sequentially. It is preferable here to orientate first longitudinally (i.e. in machine direction=MD) and then transversely (i.e. perpendicularly to the machine direction=TD). The longitudinal orientation can be carried out with the aid of two rolls running at different speeds corresponding to the desired stretching ratio. An appropriate tenter frame is generally used for transverse orientation.

The temperature at which biaxial orientation, in particular of PET, can generally be carried out can vary relatively widely and depends on the desired properties of the film. Longitudinal stretching is generally carried out at from about 80 to 140° C. and transverse stretching at from about 80 to 150° C. The longitudinal stretching ratio λ_{MD} is preferably in the range from 2.0:1 to 5:1. The transverse stretching ratio λ_{TD} is generally in the range from 2.5:1 to 5.0:1. Prior to transverse stretching, one or both surfaces of the film can advantageously be in-line-coated by the known processes, for example with the coating compositions described above. After biaxial stretching, the film can advantageously be corona- or flame-treated on one or both surfaces by one of the known methods. The treatment intensity is generally above 50 mN/m².

In the heat-setting which follows, the film is kept for from about 0.1 to 10 s at a temperature of from about 150 to 250° C. The film is then wound up conventionally.

The inventive film shows very good handling, very good winding properties and very good processing performance. It features excellent performance in peeling from the pot. The inventive film is suitable as packaging material for foods and other consumable items, in particular as lid film for food-or-drink containers, e.g. yoghurt pots. The film also has excellent suitability for the packaging of foods and other consumable items which are sensitive to moisture and/or to air and which likewise can be present in such pots.

The film according to the present invention also has excellent optical properties, shows excellent further-processing properties and shows excellent roll formation. Because the film handles well and has very good processing properties it is particularly suitable for processing on high-speed machinery. The film also has excellent whiteness, also giving the film a very attractive appearance which is effective for promotional purposes.

It has been ensured that regrind produced by way of example as cut material during film production can be reintroduced to the extrusion process during production of the film at a concentration of from about 20 to 60% by weight, based on the total weight of the film, without any significant resultant adverse effect on the physical properties of the film.

The table below (Table 1) again collates the most important properties of the film.

TABLE 1

| | | | Very | | |
|---|---|---|---|---|---|
| | | Particularly | particularly | | |
| | Preferred | preferred | preferred | Unit | Test method |
| Base layer B | | | | | |
| concentration of | 3 to 15 | 3.5 to 14 | 4 to 13 | % by wt. | |
| white pigment | | | | | |
| Outer layer A | | | | | |
| concentration of | 2 to 15 | 2.5 to 14 | 3 to 13 | % by wt. | |
| white pigment | | | | | |
| concentration of | 0.01 to 2 | 0.05 to 1.8 | 0.1 to 1.6 | % by wt. | |
| antiblocking agent | | | | | |
| d₅₀ particle | 2 to 8 | 2.1 to 7 | 2.2 to 6 | μm | |
| diameter of | | | | | |
| antiblocking agent | | | | | |
| Average roughness | 40 to 150 | 43 to 140 | 46 to 130 | nm | DIN 4762 |
| Rₐ of side A | | | | | |
| Coefficient of | ≦0.4 | ≦0.35 | ≦0.30 | | DIN 53375 |
| friction COF, side | | | | | |
| A with respect to | | | | | |
| side A | | | | | |
| Thickness of outer | 0.4 to 6 | 0.5 to 5 | 0.6 to 4 | μm | |
| layer A | | | | | |
| Film properties | | | | | |
| Film thickness | 5 to 500 | 8 to 400 | 10 to 300 | μm | |
| Berger whiteness | >60 | >65 | >70 | | See |
| of film | | | | | description |
| Transparency of | <60 | <55 | <50 | % | ASTM D1003-00 |
| film | | | | | |
| Gloss of outer | >20 | >25 | >30 | | DIN 67530 |
| layer A at 20° | | | | | |
| Contact angle of | ≦64 | ≦62 | ≦60 | ° | |
| water on coated | | | | | |
| surface of film | | | | | |

The following test methods were used to characterize the raw materials and the films:

DIN=Deutsches Institut für Normung [German Institute for Standardization]

ASTM=American Society for Testing and Materials

Transparency

Transparency is measured by a method based on ASTM D1003-00.

Roughness

The arithmetic average roughness value Rₐ is determined to DIN 4762.

Whiteness

Whiteness is determined by the Berger method, generally by mutually superposing more than 20 layers of film. Whiteness is determined with the aid of an ELREPHO electrical reflectance photometer from Zeiss, Oberkochem (DE), standard illuminant C, 2° standard observer. Whiteness WG is defined as
WG=RY+3RZ−3RX,
where RX, RY, RZ are corresponding reflectance factors using an X, Y or Z color-measurement filter. The white standard used comprises a barium sulfate pressing (DIN 5033, part 9). A detailed description is provided by way of example in Hansl Loos, Farbmessung [Color measurement], Verlag Beruf und Schule, Itzehoe (1989).

SV (Standard Viscosity)

Standard viscosity SV (DCA) is measured at 25° C. in dichloroacetic acid by a method based on DIN 53726. Intrinsic viscosity (IV) is calculated from standard viscosity as follows:
IV[η]=6.907·10⁻⁴SV(DCA)+0.063096[dl/g]

Coefficient of Friction

The coefficient of friction is determined to DIN 53 375. The coefficient of sliding friction is measured 14 days after production.

Gloss

Gloss is determined to DIN 67 530. Reflectance was measured, this being an optical value characteristic of a film surface. Using a method based on the standards ASTM D523-78 and ISO 2813, the angle of incidence was set at 20°. A beam of light hits the flat test surface at the set angle of incidence and is reflected or scattered by the surface. A proportional electrical variable is displayed, representing light rays hitting the photoelectronic detector. The value measured is dimensionless.

Measurement of Median Diameter d₅₀

Median diameter d₅₀ is determined by means of a laser on a Malvern Mastersizer, using the standard method (examples of other measurement equipment being Horiba LA 500 or Sympathec Helos, which use the same measurement principle). For the test, the specimens are placed with water in a cell and this is then placed in the measurement equipment. The measurement procedure is automatic and also includes the mathematical determination of d₅₀.

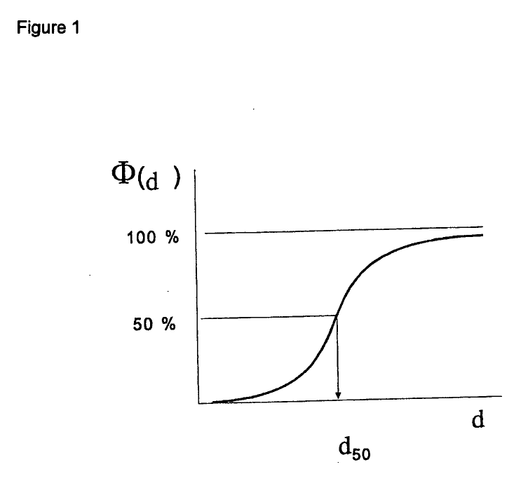

d₅₀ here is defined as determined as follows from the “relative” cumulative particle size distribution curve: the desired d₅₀ is directly given on the abscissa axis by the intersection of the 50% ordinate value with the cumulative curve. FIG. 1 illustrates in more detail what is meant by this.

Winding Performance of Film

The winding performance of the film is visually assessed when the machine roll is wound up directly after biaxial orientation.

+: Winding of the machine roll is satisfactory. No creasing, no wandering of the film web and no blocking points caused by blocking of film layers are observable.

−: Winding of the machine roll is defective. At least one of the following defects is observable: creasing, wandering of the film web, blocking points caused by blocking of film layers.

Roll Formation

Roll formation is visually assessed after slitting of the machine roll to give narrower customer rolls.

+: Winding of the customer roll is satisfactory. No creasing, no corrugations in the film web and no blocking points caused by blocking of film layers are observable.

−: Winding of the customer roll is defective. At least one of the following defects is observable: creasing, corrugations in the film web, blocking points caused by blocking of film layers.

Contact Angle with Water

Polarity of the surface is determined via measurement of the wetting angle of distilled water. The measurement was made at 23° C. and 50% rel. humidity. A metering syringe is used to apply a droplet of width 1-2 mm of distilled water to the film surface. Since the measurement is time-dependent because of heat introduced by the illumination system (vaporization), charging, or droplet-spreading, the needle remains in the droplet so that during the measurement the droplet is carefully enlarged and then the contact angle is read off immediately through a goniometer eyepiece (measurement of advancing angle). The average is calculated from 5 measurements.

Processing Performance of Film

Processing performance of the film is visually assessed during the production of lids.

+: Processing performance of the film is satisfactory. For example, no curling, no lodging of the lid in the sealing equipment etc. is observable.

−: Processing performance of the film is defective. At least one of the following defects is observable: curling, lodging of lid in sealing equipment.

### INVENTIVE EXAMPLE 1

Chips comprised of polyethylene terephthalate and polyethylene terephthalate comprising titanium dioxide as white pigment were dried and introduced into the extruder for the base layer (B). Chips comprised of polyethylene terephthalate, polyethylene terephthalate comprising titanium dioxide as white pigment and polyethylene terephthalate comprising an antiblocking agent were likewise dried and introduced into the extruder for the two (identical) outer layers (A).

Coextrusion followed by stepwise longitudinal and transverse orientation were then used to produce a white, three-layer film with ABA structure and a total thickness of 60 μm. The thickness of the two outer layers was in each case 2 μm.

Base Layer (B):

| 86% by weight of | polyethylene terephthalate whose SV is |
|---|---|
| | 800 and |
| 14% by weight of | masterbatch from Sukano (Schindellegi, |
| | CH) with 50% by weight of rutile |
| | titanium dioxide (median particle |
| | diameter of titanium dioxide about |
| | 0.3 μm) and 50% by weight of |
| | polyethylene terephthalate whose SV is |
| | 800. |

outer layer (A), a mixture comprised of

| | |
|---|---|
| 70% by weight of | polyethylene terephthalate whose SV is |
| | 800, |
| 14% by weight of | masterbatch from Sukano (Schindellegi, |
| | CH) with 50% by weight of rutile |
| | titanium dioxide (median particle |
| | diameter of titanium dioxide about |
| | 0.3 μm) and 50% by weight of |
| | polyethylene terephthalate whose SV is |
| | 800 and |
| 16% by weight of | masterbatch comprised of 97.5% by weight |
| | of polyethylene terephthalate (SV 800) |
| | and 2.5% by weight of SYLOBLOC ® 44 H |
| | (synthetic SiO₂ from Grace, |
| | diameter = 2.5 μm). |

The production conditions in the individual steps of the process were:

| | | | |
|---|---|---|---|
| Extrusion | Temperatures | Layer A: | 280° C. |
| | | Layer B: | 280° C. |
| | | Layer A: | 280° C. |
| | temperature of | | 20° C. |
| | take-off roll | | |
| longitudinal | temperature | | 70-120° C. |
| stretching | | | |
| | longitudinal | | 3.2 |
| | stretching ratio | | |
| transverse | temperature | | 80-135° C. |
| stretching | | | |
| | transverse | | 3.8 |
| | stretching ratio | | |
| setting | temperature | | 230° C. |
| | duration | | 3 S |

The product was a film with very good optical properties, with very good winding performance, with very good winding quality and with very good processing performance. The film showed the desired performance during peeling of the film from the pot.

### INVENTIVE EXAMPLE 1a

A film was produced as described in inventive example 1, but after setting this was corona-treated (2 kW/m²) on one side. The film had the properties of the film from inventive example 1 and also improved adhesion; the contact angle with water was 63.7°.

### INVENTIVE EXAMPLE 1b

The film was produced as in inventive example 1. The process below was used to apply, to the layer C of the polyester film, an adhesion-promoter coating which comprises a latex with 4.5% solids content, comprised of a copolymer of 60% by weight of methyl methacrylate, 35% by weight of ethyl acrylate and 5% by weight of N-methylolacryamide and a surfactant:

The longitudinally stretched film was corona-treated (8 kW/m²) and then coated with the latex described above on the layer A via reverse gravure coating.

The biaxially stretched film was heat-set at 230° C. The dry weight of the coating was about 0.035 g/m² with a coating thickness of about 40 nm.

The desirable and inventive properties of the film were as in inventive example 1. The contact angle with water was 63.8°. The film was tested for its reprographic adhesion, the result being good adhesion.

### INVENTIVE EXAMPLE 1c

The film was produced as in inventive example 1b. The following process was used to apply, to the polyester film, a coating comprising an aqueous dispersion with 6% by weight of copolyester, comprised of 95 mol % of isophthalate, 5 mol % of sodium 5-sulfoisophthalate and 100 mol % of ethylene glycol, and 0.56% by weight of colloidal SiO₂:

The longitudinally stretched film was coated with the copolyester dispersion described above on the layer A via reverse gravure coating.

The biaxially stretched film was heat-set at 230° C. The dry weight of the coating was about 0.030 g/m² with a coating thickness of about 35 nm.

The sealing properties and peel properties of the film were as in inventive example 1. The contact angle with water was 57°.

Two specimens of the single-side-coated film thus produced were introduced into a vacuum laboratory coater and specifically in such a way that the coated side of one of the specimens and the uncoated side of the other specimen was metallized. The vacuum chamber was evacuated to below 10 Torr and about 500 Å of aluminum were metallized both onto the uncoated side and onto the coated specimen from a tungsten filament.

Within 30 s after removal from the vacuum chamber, “metal abrasion” was tested on each specimen. For this, a cotton nonwoven was used to rub the metal surface lightly, using the same number of strokes and about the same pressure on each tested specimen. The “abrasion performance” of the coated side of the film was evaluated as good.

### INVENTIVE EXAMPLE 1d

The film was produced as in inventive example 1. The process below was used to apply, to a polyester film, a coating comprising an aqueous dispersion with 7% by weight of solids content, comprised of 50% by weight of the aromatic copolyester A1 (copolyester containing 90 mol % of terephthalate, 10 mol % of sodium 5-sulfoisophthalate, 80 mol % of ethylene glycol and 20 mol % of diethylene glycol), 45% by weight of the water-dispersible polymer B2 (polyvinyl alcohol whose degree of hydrolysis is 88 mol % and whose degree of polymerization is 1700) and 5% by weight of inert particles D1 (colloidal SiO₂ whose particle diameter is 0.05 μm):

The longitudinally stretched film was coated with the copolyester dispersion described above via reverse gravure coating. The dry weight of the coating was about 0.040 g/m² with a coating thickness of about 0.05 μm.

The sealing properties and peel properties of the film were as in inventive example 1. The contact angle with water was 50.0°.

To assess the adhesion-promoter effect of the coating, an aqueous polyvinyl acetal solution (S-LEC KX-1, produced by Sekisui Chemical Co., Ltd.; hereinafter termed KX-1) was applied to the coated film and dried. The concentration of the coating solution was 8% by weight and it was applied with a layer thickness of 127 μm by a Baker applicator. The coated film was immediately placed in an oven for 4 min for drying at 100° C. An ink-jet printer (BJC-600J, Canon Inc.) was used to print a black square (area: 12×12 cm) onto the surface of the dried KX-1 coating and the print was dried in air at 23° C. and 50% relative humidity for 12 h. An adhesive tape (Cello-tape, Nichiban Inc., width: 18 mm) was adhesive-bonded to the printed area and rapidly peeled away. The extent to which the printed surface was removed with the adhesive tape was determined visually. The coated film showed good adhesion properties.

### INVENTIVE EXAMPLE 2

In comparison with inventive example 1, only the constitution of the outer layers (A) was now changed. All of the other parameters were retained.

Outer layer (A), a mixture comprised of:

| | |
|---|---|
| 82.6% by weight of | polyethylene terephthalate whose SV is |
| | 800, |
| 5.4% by weight of | masterbatch from Sukano (Schindellegi, |
| | CH) with 50% by weight of rutile |
| | titanium dioxide (median particle |
| | diameter of titanium dioxide about |
| | 0.3 μm) and 50% by weight of |
| | polyethylene terephthalate whose SV is |
| | 800 and |
| 12% by weight of | masterbatch comprised of 97.5% by weight |
| | of polyethylene terephthalate (SV) 800 |
| | and 2.5% by weight of SYLOBLOC ® 44 H |
| | (synthetic SiO₂ from Grace, |
| | diameter = 2.5 μm). |

### INVENTIVE EXAMPLE 3

In comparison with inventive example 1, the base layer (B) was changed. All of the other parameters were retained.

Base Layer (B):

| 35% by weight of | polycondensation polymer from Invista |
|---|---|
| | (DE) with 20% by weight of anatase |
| | titanium dioxide (median particle |
| | diameter of titanium dioxide about |
| | 0.32 μm) and 80% by weight of |
| | polyethylene terephthalate whose SV is |
| | 800 and |
| 65% by weight of | polyethylene terephthalate whose SV is |
| | 800. |

### COMPARATIVE EXAMPLE 1

In comparison with inventive example 2, only the constitution of the outer layers (A) was now changed. The PET MB with the antiblocking agent was omitted in the outer layers. All of the other parameters were retained.

Outer layer (A), a mixture comprised of:

| 94.6% by weight of | polyethylene terephthalate whose SV is |
|---|---|
| | 800 and |
| 5.4% by weight of | masterbatch from Sukano (Schindellegi, |
| | CH) with 50% by weight of rutile |
| | titanium dioxide (median particle |
| | diameter of titanium dioxide about |
| | 0.3 μm) and 50% by weight of |
| | polyethylene terephthalate whose SV is |
| | 800. |

### COMPARATIVE EXAMPLE 2

Example 1 of EP-B-0 605 130 was repeated. Because of its layer structure, the film showed a marked tendency toward curling, which is highly disadvantageous. The film also has disadvantages in roll formation and in processing performance.

### COMPARATIVE EXAMPLE 3

Example 1 of EP-A-1 176 004 was repeated. The film had disadvantages in winding performance, in roll formation and in processing performance.

Table 2 collates the results of the inventive examples/comparative examples.

TABLE 2

| | | | | | | | | Coef- | | | |
|---|---|---|---|---|---|---|---|---|---|---|---|
| | | | | | | | | ficient | | | |
| | | | | | | | | of | | | |
| | | | | | | | | friction | | | |
| | | | | Gloss | | | Average | COF, side | | | |
| | | | | 20° | | | rough- | A with | | | |
| | | Film | Trans- | measurement | | | ness Rₐ | respect | Winding | Roll | |
| | | white- | parency | angle | | Contact | of side | to side | perfor- | form- | Processing |
| | | ness | % | Side A | Side C | angle° | A nm | A | mance | ation | performance |
| A | 1 | 93 | 30 | 54 | 53 | | 50 | 0.27 | + | + | + |
| | 0 | 93 | 30 | 54 | 53 | 63.7 | 50 | 0.27 | + | + | + |
| | 1b | 93 | 30 | 54 | 53 | 63.8 | 50 | 0.27 | + | + | + |
| | 1c | 93 | 30 | 54 | 53 | 57 | 50 | 0.27 | + | + | + |
| | 1d | 93 | 30 | 54 | 53 | 50 | 50 | 0.27 | + | + | + |
| | 2 | 93 | 30 | 56 | 58 | | 48 | 0.29 | + | + | + |
| | 3 | 91 | 28 | 58 | 60 | | 48 | 0.27 | + | + | + |
| B | 1 | 93 | 30 | 60 | 60 | | 34 | 0.42 | − | − | − |
| | 2 | 94 | 28 | 65 | 100¹⁾ | | 35 | 0.48 | − | − | − |
| | 3 | 90 | 28 | 60 | 60²⁾ | | 35 | 0.49 | − | − | − |

¹⁾Transparent side
²⁾Monofilm
Key
A Inventive example
B Comp. example

That which is claimed:

1. A white, biaxially oriented polyester film comprising a base layer (B) and at least one outer layer (A), wherein
a) the base layer (B) comprises a concentration of from 3 to 15% by weight of a whitening pigment and
b) the outer layer (A) comprises a concentration of from 2 to 15% by weight of a whitening pigment and also from 0.01 to 2% by weight of an antiblocking agent whose median particle diameter (d₅₀) is from 2 to 8 μm.

2. The polyester film as claimed in claim 1, wherein the whitening pigment in at least one of the base layer (B) or the outer layer (A) is titanium dioxide.

3. The polyester film as claimed in claim 1, wherein the whitening pigment in the base layer (B) and in the outer layer (A) is titanium dioxide.

4. The polyester film as claimed in claim 2, wherein the titanium dioxide in the base layer is of anatase type.

5. The polyester film as claimed in claim 2, wherein the titanium dioxide is in at least the outer layer (A), and the titanium dioxide is of rutile type.

6. The polyester film as claimed in claim 1, wherein the antiblocking agent in the outer layer (A) is silicon dioxide.

7. The polyester film as claimed in claim 1, wherein the base layer (B) comprises at least 80% by weight of a thermoplastic polyester.

8. The polyester film as claimed in claim 7, wherein the thermoplastic polyester of the base layer (B) comprises units of ethylene glycol and terephthalic acid and/or units of ethylene glycol and naphthalene-2,6-dicarboxylic acid.

9. The polyester film as claimed in claim 7, wherein the thermoplastic polyester of the base layer (B) is polyethylene terephthalate.

10. The polyester film as claimed in claim 7, wherein the outer layer (A) comprises thermoplastic polyester and the thermoplastic polyester of the base layer (B) and the thermoplastic polyester of the outer layer (A) are identical.

11. The polyester film as claimed in claim 1, which has an ABC layer structure, where the outer layers (A) and (C) are identical or different.

12. The polyester film as claimed in claim 1, which has an ABA layer structure.

13. The polyester film as claimed in claim 1, wherein the average roughness of the outer layer (A) of the film is from 40 to 150 nm.

14. The polyester film as claimed in claim 1, wherein the coefficient of friction of the outer layer (A) with respect to the outer layer (A) is less than or equal to 0.4.

15. The polyester film as claimed in claim 1, whose Berger whiteness is greater than 60.

16. The polyester film as claimed in claim 1, wherein at least one surface of the film has been corona-treated.

17. The polyester film as claimed in claim 1, wherein the film further comprises a functional layer and the functional layer is an adhesion-promoting layer.

18. The polyester film as claimed in claim 17, wherein the adhesion-promoting layer comprises a copolyester.

19. The polyester film as claimed in claim 17, wherein the adhesion-promoting layer is an acrylate layer.

20. The polyester film as claimed in claim 17, wherein the adhesion-promoting layer is a hydrophilic layer.

21. The polyester film as claimed in claim 17, wherein the contact angle of the adhesion-promoting layer with water is less than or equal to 64°.

22. A process for production of a polyester film as claimed in claim 1 comprising the steps of
a) producing a multilayer film via coextrusion,
b) optionally, functionally coating or treating one or more surfaces of the film,
c) biaxially stretching the film and
d) heat-setting the stretched film.

23. Packaging material for foods and other consumable items comprising polyester film as claimed in claim 1.

24. Lid film for food-or-drink containers comprising polyester film as claimed in claim 1.

25. Lid film for food-or-drink containers as claimed in claim 024, wherein the container is a yoghurt pot.
